(19) United States
(12) Patent Application Publication
(10) Pub. No.: US 2025/0378664 A1
(43) Pub. Date: Dec. 11, 2025

(54) SYSTEM AND METHOD FOR PERSONALIZED AVATAR GENERATION USING PHOTO IMAGE ANALYSIS

(71) Applicants: Constructor Technology AG, Schaffhausen (CH); Constructor Education and Research Genossenschaft, Schaffhausen (CH)

(72) Inventors: Sergey Aksenov, Belgrade (RS); Serg Bell, Costa del Sol (SG); Stanislav Protasov, Singapore (SG); Laurent Dedenis, Singapore (SG); Nikolay Dobrovolskiy, Istambul (TR)

(21) Appl. No.: 18/737,565

(22) Filed: Jun. 7, 2024

(51) Int. Cl. G06T 19/20; G06T 7/194; G06T 7/73

(52) U.S. Cl. CPC G06T 19/20; G06T 7/194; G06T 7/73; G06T 2200/24; G06T 2207/30196; G06T 2219/2004

(57) ABSTRACT

Systems and methods for generating a personalized three-dimensional avatar model are disclosed. A method includes generating pose data by identifying key points on a body figure mapped on user photographic images, loading a three-dimensional avatar model template based on persona characteristics and aligning the avatar model template with pose data to position the avatar in a corresponding posture. The personalized avatar model is generated using gradient descent optimization to adjust avatar model parameters based on a comparison of aligned avatar model with user images.

### TECHNICAL FIELD

The invention relates generally to digital avatar creation and personalization. More particularly, the invention relates to the generation and customization of three-dimensional avatar models based on photographic images and pose data analysis.

### BACKGROUND

Avatar generation, particularly creating personalized, realistic virtual representations are used in digital platforms such as gaming, virtual reality (VR), social media, and professional simulations.

Traditional systems for avatar generation have made significant strides in recent years, driven by increasing demands for personalized avatars in various digital environments. However, these systems often struggle to produce avatars that accurately reflect individual human specifics, such as body figures and facial features, leading to a lack of personalization and realism.

A significant challenge arises when attempting to create avatars that are not only realistic but also capture the uniqueness of a user's physical attributes. Traditional systems that focus on avatar generation often fail to precisely mirror individual physical characteristics. Existing solutions may not provide the necessary degree of realism without extensive customizations, which can be cumbersome and computationally intensive. This complexity often necessitates significant manual input or reliance on advanced algorithms, posing a barrier for users seeking quick avatar creation and limiting the scalability of these solutions, especially for users with less advanced devices.

Therefore, there is a need for an optimized avatar generation tool that efficiently produces high-quality, detailed, and realistic avatars, minimizing the need for manual customization and computational resources, making avatar creation more accessible and user-friendly.

### SUMMARY

Embodiments described or otherwise contemplated herein substantially meet the aforementioned needs of the industry. Systems and methods provide a personalized three-dimensional avatar model by generating pose data by identifying key points on a body figure mapped on user photographic images, loading a three-dimensional avatar model template based on persona characteristics and aligning the avatar model template with pose data to position the avatar in a corresponding posture. In an example, a personalized avatar model is generated using gradient descent optimization to adjust avatar model parameters based on a comparison of the aligned avatar model with user images.

In an embodiment, a computer implemented method for generating a personalized three-dimensional avatar model, comprises receiving at least one photographic image of a persona; preprocessing the received image to extract a body figure of a persona for further processing; generating pose data from the preprocessed image by identifying key points of the body figure mapped to a coordinate space; loading a three-dimensional avatar model template, wherein the three-dimensional avatar model template is selected based on persona characteristics; aligning the three-dimensional avatar model template with the generated pose data to position the three-dimensional avatar model in a posture corresponding to the pose data; performing gradient descent optimization, comprising: calculating a loss function applied to projection of the aligned three-dimensional avatar model and the body figure of the preprocessed image, and adjusting at least one parameter of the three-dimensional avatar model parameter if the loss function value exceeds an accuracy threshold; customizing the adjusted three-dimensional avatar model at an avatar customization unit to include user-specific features; and storing the personalized three-dimensional avatar model in a storage unit for subsequent retrieval and use.

In an embodiment, a system for generating a personalized three-dimensional avatar model comprises at least one processor and memory operably coupled to the at least one processor; instructions that, when executed by the at least one processor, cause the at least one processor to execute: an image preprocessing unit configured to receive and preprocess at least one photographic image of a persona to extract a body figure of the persona for further processing; a pose detection unit configured to generate pose data from the preprocessed image by identifying key points of the body figure mapped to a coordinate space; an avatar generation unit configured to load a three-dimensional avatar model template, wherein the template is selected based on persona characteristics, and align the template with the generated pose data to position the three-dimensional avatar model in a posture corresponding to the pose data; an optimization unit within the avatar generation unit configured to perform gradient descent optimization by calculating a loss function applied to the projection of the aligned three-dimensional avatar model and the body figure of the preprocessed image, and adjusting at least one parameter of the three-dimensional avatar model if the loss function value exceeds an accuracy threshold; an avatar customization unit within the avatar generation unit configured to customize the adjusted three-dimensional avatar model to include user-specific features; and a database configured to store the personalized three-dimensional avatar model for subsequent retrieval and use.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. 1 is a block diagram of an avatar generation system, in accordance with an embodiment.

FIG. 2 is a functional block diagram of a system for personalized avatar generation using photo image analysis, in accordance with an embodiment.

FIG. 3 is a photographic image of a person overlaid with pose data, in accordance with an embodiment.

FIG. 4 is a base 3D avatar model in two distinct projections, in accordance with an embodiment.

FIG. 5 is flowchart of a method for generating a personalized three-dimensional avatar model, in accordance with an embodiment.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION

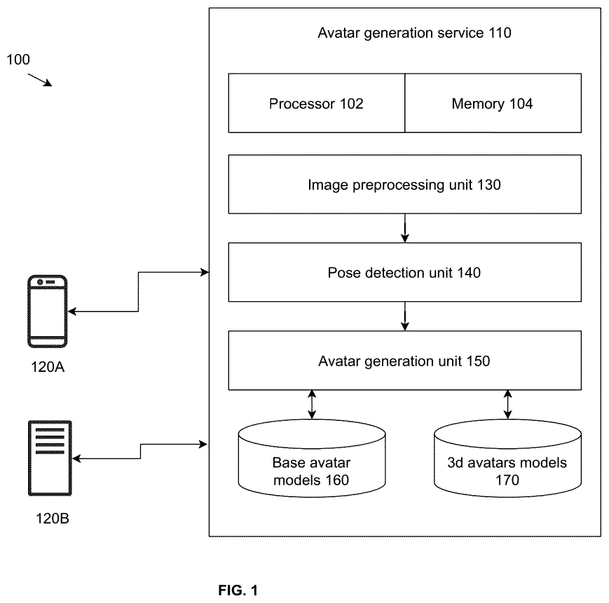

FIG. 1 illustrates a block diagram of an avatar generation system 100 that comprises various components and data flow processes for the creation of personalized 3D avatar models. System 100 includes an avatar generation service 110 which receives input data from a user's device 120A such as a smartphone or digital camera. In an embodiment, the avatar generation system 100 can also communicate with external services or systems 120B. This interoperability allows the generated avatars to be utilized across a suite of integrated systems, enhancing the user's digital presence and personalization in various applications. External services (120B) can include gaming platforms, social networks, educational tools, or professional training simulations, where the avatars may serve as digital stand-ins for the users.

The input data from user devices 120A of 3rd party services 120B typically includes photographic images or other visual information associated with the user. The avatar generation service 110 can process a diverse array of image inputs to create detailed and personalized avatars. In one embodiment, the avatar generation service 110 can utilize images captured from different angles, providing a 360-degree view of the subject, which allows for the creation of a more accurate and life-like avatar. Another embodiment includes processing of both full-body images, which are crucial for generating a complete avatar with accurate body proportions, and part-body images, like portraits, which are essential for refining facial features and expressions. Moreover, the avatar generation service 110 can also process video footage of a person, extracting key frames and poses to construct a dynamic and animated representation of the user. In yet another embodiment, the avatar generation service 110 can analyze a sequence of images depicting various poses and expressions to capture the subtleties of the subject's gestures and emotional range, further enhancing the realism of the avatar.

Avatar generation service 110 generally comprises at least one processor 102 and a memory 104 operably coupled to at least one processor 102. Memory 104 can store instructions that, when executed by at least one processor 102, cause at least one processor 102 to implement a number of engines or units, including image preprocessing unit 130, pose detection unit 140, and avatar generation unit 150.

Once the user's data is received (e.g. by device 120A), it is first processed by image preprocessing unit 130 within the avatar generation service 110. Image preprocessing unit 130 is configured for preparing the images for further analysis, which can include tasks such as resizing, filtering, or color correction to ensure that the images are suitable for avatar generation. For an image to be suitable for avatar generation, the image must exhibit high resolution for detailed analysis, appropriate lighting to prevent feature-obscuring shadows, and a neutral background for easy figure isolation. The image preprocessing unit 130 ensures image conditions are met through operations such as resizing, which standardizes image dimensions; filtering, which enhances clarity and emphasizes essential features; and color correction, which adjusts the image to represent true-to-life colors. In embodiments, preprocessing of multiple images of the same user improves the ability to create a better avatar (e.g. more accurate, more efficient processing).

Following one or more preprocessing operations, the data flows to pose detection unit 140. Pose detection unit 140 analyzes the preprocessed images to detect the pose of the user. A detected pose from a single image is a set of identified key points on the subject's body figure, which correspond to significant anatomical landmarks. The detection process extrapolates these points to discern the spatial orientation and arrangement of the body parts at a given instant.

The processed pose information is then conveyed to avatar generation unit 150, which utilizes the pose data along with other inputs, such as parameters of weight, height and external signs of a person, to create a personalized avatar for the user. Avatar generation unit 150 employs algorithms to map the user's physical characteristics onto a virtual 3D model. Avatar generation unit 150 operates in conjunction with a database or repository of base avatar models 160. Base avatar models repository 160 stores a variety of pre-designed avatar templates that provide the foundational shapes and features from which the personalized avatars are derived. In one embodiment, pre-designed avatar templates are 3D models stored in 3D file formats such as OBJ, FBX, or STL, which are compatible with various software and platforms used in digital environments.

In an embodiment, pre-designed avatar templates correspond to generic personas characterized by specific demographic and physical attributes such as age, sex, weight, height, or nationality. Pre-designed avatar templates serve as foundational models that reflect the general physical characteristics and aesthetic features typical of diverse user groups. Each template is crafted to represent a baseline figure for its designated category, allowing for a quicker and more streamlined avatar creation process. Users can select personal parameters or a template closest to their personal demographics as a starting point. Avatar generation unit 150 customizes the selected template using detailed user-provided data, such as photographs or biometric information, to adjust the generic features into a more personalized and distinctive avatar.

The result of system 100 operation is the creation of a 3D avatar model. A 3D avatar model is a digital construct, comprising a complex array of data, which corresponds to points or vectors of the avatar surface points in 3D space, that represents a persona in three dimensions. Avatar models are stored in 3D avatar models storage 170 in formats such as OBJ, FBX, or STL, which are widely recognized for their ability to maintain detailed information about the geometry, textures, and colors of 3D objects. These formats ensure compatibility with a broad range of software and platforms used in digital environments. In terms of content, a 3D avatar model can include metadata elements that include information such as use case scenarios, creation date, and version details. Metadata can also include parameters of skin tone, eye color, hair style, or clothing preferences. Additionally, the 3D avatar model can encapsulate physical characteristics derived from the user input data, such as body measurements and facial features. For example, 3D model formats that support parametrized metadata include FBX (Filmbox), COLLADA (Collaborative Design Activity), and USD (Universal Scene Description). FBX is extensively utilized within the film and gaming industries, accommodating complex metadata related to rigging, animations, and diverse attributes that dictate the model's appearance and functionality in different environments. COLLADA, an XML-based format, streamlines the interchange of digital assets across various graphics software, supporting extensive metadata for asset customization and attribute specification. USD, crafted by PIXAR, is configured to manage intricate scenes and maintains detailed metadata about the components and their interrelationships within the scene, including comprehensive character model descriptions.

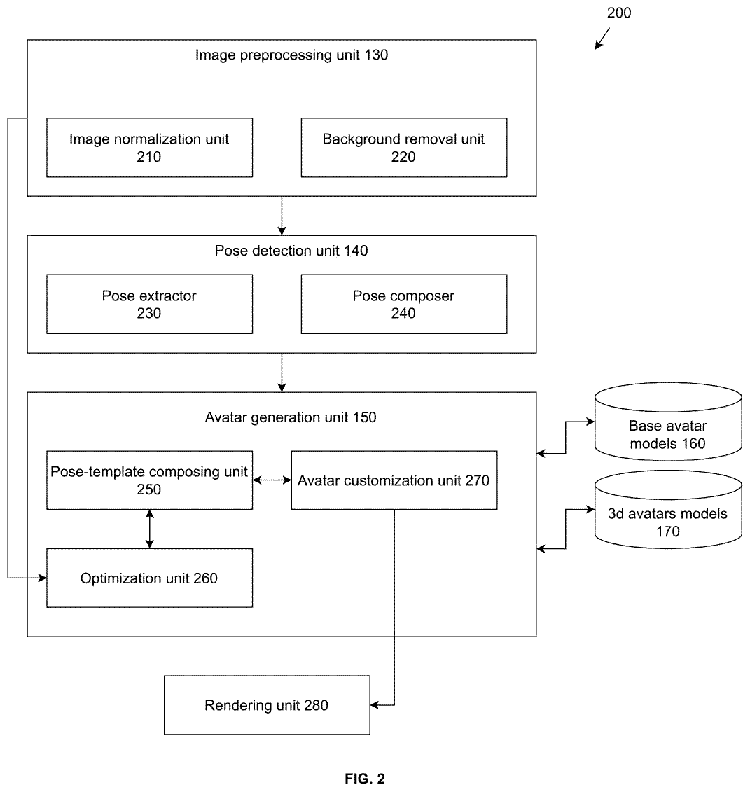

Referring to FIG. 2, a functional block diagram of system 200 for personalized avatar generation using photo image analysis is depicted, according to an embodiment. The system 200 includes an image preprocessing unit 130, which is configured for preparing images provided by a user for further processing. The image preprocessing unit 130 can utilize various image formats, including JPEG, PNG, BMP, and TIFF, which are widely utilized across digital mediums. In one embodiment, the image preprocessing unit 130 can process and employ EXIF data from images, providing information on camera settings, image capture time, and location data, that help to detect a pose and body parameters more accurately and customize an avatar rapidly.

An image normalization unit 210 is configured for standardizing input images to ensure consistency before they undergo further analysis. The image normalization unit 210 performs various operations to adjust the images, such as resizing the images to a standard scale, cropping to focus on relevant sections, and adjusting color parameters to enhance feature recognition and machine learning analysis. By normalizing the images, image normalization unit 210 facilitates the accurate detection of key points and features in subsequent processing stages, such as pose detection and avatar customization, according to an embodiment.

A background removal unit 220 separates the user from the background and removes background in the input images. Background removal unit 220 utilizes algorithms and tools designed for background detection and removal. These include chroma keying methods suitable for uniform background colors and machine learning models like U-Net or Mask R-CNN for complex backgrounds. Libraries such as OpenCV provide functions for background processing. Additionally, dedicated services like the Remove.bg API are available for specialized background removal tasks. The effectiveness of background removal unit 220 depends on factors such as the clarity of the user's outline against the background, the contrast levels between the user and the background, and the lighting conditions in the image. By successfully isolating the figure of the user or person, that is the subject of avatar generation, from the background, the background removal unit 220 prepares the image for subsequent processing stages, including pose detection and avatar generation, according to an embodiment.

The pose detection unit 140 within system 200 is configured for identifying the posture of a human figure from provided images. Pose detection unit 140 includes a pose extractor 230 that detects key anatomical points in an image, facilitating the construction of a pose profile for the user. In another embodiment, the pose detection unit 140 comprises a pose composer 240, which synthesizes pose data from a series of images or video frames to create a comprehensive pose profile.

In one embodiment of the system 200, the pose detection unit 140 is designed to work with images where the user maintains a consistent pose. In this scenario, the user is instructed to hold a specific posture while multiple photos are captured. The pose extractor 230 within the pose detection unit 140 analyzes each image independently, identifying key anatomical points. In one embodiment, the pose extractor 230 within the pose detection unit 140 utilizes machine learning models to identify key anatomical points from images. ML models used for this purpose include Convolutional Neural Networks (CNNs) and variations of pose estimation architectures such as OpenPose, PoseNet, or AlphaPose. The ML models are trained on datasets of annotated images where key body points are marked to learn how to accurately predict similar points in new images. Libraries like TensorFlow or PyTorch facilitate the development and implementation of these models. The training process involves feeding ML models an amount of image data labeled with precise locations of body joints (such as elbows, knees, wrists, and ankles). The ML models are trained to detect patterns and features that are indicative of human anatomy, even in varying poses and under different lighting conditions. After training, the pose extractor 230 applies the trained model to new images to detect anatomical keypoints with high accuracy. Once key points are identified in each image, the pose composer 240 combines keypoints from different images into a unified pose profile. A combination is typically achieved through algorithms that normalize the pose data across different images, ensuring that the pose is consistent even if the images were taken from different angles or distances. Techniques such as affine transformations, which adjust key points to a common coordinate system, or averaging methods, which calculate the median coordinates of each keypoint across multiple images, are used.

This aggregation enhances the accuracy of the pose representation, as it consolidates data from multiple perspectives.

In another embodiment, the pose detection unit 140 processes each image in parallel, aligning detected skeletal data describing the pose with the person's body parameters. This method is particularly effective when images display the user in varying postures. The pose extractor 230 independently analyzes each image for key anatomical points using machine learning models specifically tailored for pose estimation. Following the extraction of keypoints, the pose composer 240 aligns key body points with the user's body dimensions, including scaling and transforming the detected key points to fit the specific dimensions and proportions of the user's body. Algorithms such as Procrustes Analysis or affine transformation techniques are used to ensure that the key points from different images correspond accurately to the same anatomical body points on the user.

Furthermore, in a different embodiment, the system 200 is configured for scenarios where each photo features the user in different postures. The pose extractor 230 detects the unique pose in each image, and the pose composer 240 synthesizes these diverse pose data to create a comprehensive pose profile. The pose detection unit 140 focuses on accurately capturing the proportions of body fragments in relation to detected poses. When users are photographed in different postures, and once keypoints are detected by the pose extractor 230, the pose composer 240 is responsible for synthesizing this data into a comprehensive pose profile. This synthesis involves aligning and integrating the detected key points from multiple images to accurately represent the user's range of motion and the relative proportions of different body segments. Techniques such as geometric morphometrics or advanced skeletal fitting algorithms are applied to ensure that the keypoints are not only merged but also scaled and oriented according to the actual proportions of the user's body. This method facilitates the creation of a dynamic pose profile that incorporates the positional and proportional variances of the body parts, as observed across the different images. In this embodiment, pose profile not only reflects the individual poses but also encompasses a synthesized representation of the body's dimensions and joint orientations, providing a detailed and accurate base for generating a personalized avatar.

The pose data referred to as pose profile is structured to store key parameters necessary for detailed avatar modeling. Each component within the profile is linked to ensure coherence and utility across various embodiments of the pose extractor 230 and pose composer 240, accommodating different image processing techniques such as sequential, parallel and pose integration from varied postures, described above. Keypoint coordinates are stored within a multi-dimensional array where each coordinate (x, y, z) represents a specific anatomical key point identified across a series of images. In an embodiment, joint angles are computed and recorded in pose profile in relation to the key points, forming a matrix that details the angular relationships between each joint pair. In scenarios involving parallel processing, each image's data is independently integrated into the overall matrix, ensuring no loss of posture information. For sequential image processing, this matrix is incrementally updated, allowing for a cumulative understanding of posture over a series of images. When integrating pose data from different postures, the matrix is configured to include variability and range of motion. In one embodiment, proportional metrics are calculated based on the distances between various key points and are stored within the profile data structure. Parallel processing can average these metrics across multiple images for consistency, and sequential processing can adapt these metrics as more data becomes available. In another embodiment, motion data, relevant in dynamic scenarios where the pose changes over time, is stored in the pose profile as a sequence of key points, with each sequence corresponding to a frame or image in the series. In yet another embodiment, pose profile can include confidence scores associated with each measurement parameter (key points, angles, and metrics) that indicate the reliability of data entry. The confidence scores are used while synthesizing digital avatar by prioritizing more reliable data.

The avatar generation unit 150 operates by selecting and loading a base avatar model from a collection of pre-designed avatar models. Base model selection is based on the user characteristics such as age, gender, weight, and height, or alternatively, on the body proportions identified by the pose detection unit 140.

The pose-template composing unit 250 within the avatar generation unit 150 aligns the base avatar model with the pose data extracted from input images. If the images depict the user in various poses, the pose-template composing unit 250 adjusts the base avatar model to each posture. The parameters of the pre-designed avatar template are tuned in accordance to calculated pose profile data, including proportional metrics and joint angles. The result of the pose-template composing unit is a 3D avatar base model or a set of 3D avatar base models that mirrors the body figure and postures in the input images.

Customization of the base avatar model is performed at the avatar customization unit 270, where changes to features like hair style, clothing, and other attributes are made to resemble the person in the photo images. Customization of the base avatar is performed by overlaying a 3D avatar model with various preconfigured 3D models of clothes, hairs, accessories and other external avatar features. In one embodiment, customization of the base avatar model is performed by applying a texture pattern to the surface of the avatar model. In one embodiment the customization of the avatar is applied to the avatar template model.

The optimization unit 260 optimizes the 3D avatar model parameters, aligning the 3D avatar model with the 2D photographic images. The optimization is based on comparison of projections of the 3D avatar model with images with removed background.

The projection of the avatar model can be captured using different techniques. Generating a projection can be implemented at pose-template composing unit 250, at optimization unit 260 or at avatar generation unit 150 as a general function in different embodiments.

In one embodiment, the pose enables the system to position the 3D avatar model in a posture that mirrors the user's posture in the photographs. In this case the pose-template composing unit 250 generates 2D avatar model projections as an output and transfers them to the optimization unit 260 for 3D avatar model adjustment.

In an embodiment, the system utilizes EXIF metadata from the photographic images to guide the positioning and focusing of a virtual camera within the 3D environment. EXIF metadata, including details of the camera focal length and orientation, is instrumental in replicating the perspective and pose present in the user's photographs. Following the adjustment of the virtual camera settings, a projection of the 3D avatar model is captured. This projection serves as a two-dimensional representation for comparison purposes.

The optimization unit 260 employs image processing algorithms to compare the projection of the avatar model with the photographic images with removed background. In an embodiment, the optimization unit 260 utilizes a loss function to assess differences between the user photographic images and the avatar model's projections.

In one embodiment, the loss function evaluates the disparity in the areas covered by the user figure in the images and area covered by the avatar model projection. The loss function involves quantifying the square of the figures, which includes measuring the area occupied by the user in each image and comparing it to the area the avatar model covers in corresponding projection. A mean squared error formula is used to calculate area differences.

In another embodiment, a loss function compares silhouettes referred to as contours. The loss function assesses the congruence between the outline of the avatar model and the user's figure in the images. Specifically, the loss function can compute the pixel-wise difference between the silhouettes, considering variances in shape and how accurately the avatar model reflects the posture of the user on an image.

In yet another embodiment, the loss function can incorporate a feature alignment measurement aspect. The loss function focuses on aligning specific physical landmarks or facial features between the user images and the avatar model projections. The function quantifies any misalignment, aiding in fine-tuning the avatar model to enhance feature congruence.

In yet another embodiment, the loss function includes texture and color comparison. This aspect ensures the avatar model not only aligns in shape and posture but also mirrors the user's skin tone, clothing texture, and other visual characteristics.

The optimization unit 260 can implement a composite function combining silhouette accuracy, which assesses the match between the avatar's outline and the user's image silhouette; feature alignment, which quantifies discrepancies in key facial and body landmarks; and color matching, which measures the fidelity of colors, focusing on aspects like skin tone and clothing. A multifaceted approach allows for simultaneous optimization of multiple elements, yielding an avatar that is both accurate and visually representative of the user.

In the avatar generation system 200, the optimization unit 260 employs gradient descent techniques for refining the avatar model to closely match the user's physical appearance. Gradient descent involves iterative adjustments of various parameters of the avatar model, driven by a specific loss function.

One embodiment of the gradient descent process includes simultaneous adjustments of multiple avatar model parameters within a single iteration. These adjustments include a range of features from general body proportions to limb lengths, facial features, and specific posture alignments. For example, in refining an avatar model's height, arm length, and facial structure using gradient descent techniques, the process involves setting initial model parameters, defining a specific loss function to quantify discrepancies in these dimensions against user images, and computing gradients of the loss function for each parameter. Each gradient indicates how a small change in the parameter affects the overall discrepancy. Through iterative updates where parameters are adjusted in the direction that reduces the loss, the model simultaneously refines multiple attributes. This iterative process continues until the loss function converges to a minimum, signaling minimal benefit from further adjustments, resulting in an avatar that accurately mirrors the user's physical features and proportions

In another embodiment, the avatar model parameters are categorized based on their level of detail and relevance, with each category being adjusted in stages. The initial stage focuses on general body figure proportions, such as height and torso dimensions. Subsequently, optimization unit 260 addresses specific body parts like arms and legs, refining these sections for a detailed customization. Following this, smaller body components such as hands, fingers, and distinct facial features are adjusted for precision. Finally, minute features like skin texture, hair style, and facial expressions are refined, adding to the avatar's realism.

In the avatar generation unit 140, certain scenarios arise where standard avatar model parameter adjustments within predefined limits do not adequately reduce the loss function. This situation can occur in cases where the user's body has unique characteristics, such as the absence of a limb or pregnancy, or when the input images lack sufficient information, like missing perspectives of the body. To address these challenges, the system is equipped with specialized handlers designed to resolve such discrepancies.

In one embodiment, when the optimization process encounters a scenario where parameter adjustments fail to lower the loss function significantly, a specialized handler is activated. This handler is configured for analyzing the avatar parameters that are determined to be difficult to align with the user's images. Once identified, the handler determines the cause of the misalignment and initiates a response protocol.

For instance, if the system detects that the user's images do not provide a complete view of the body, such as missing side or back views, the handler can request additional photographs from the user. The handler guides the user to capture images in specific poses or from particular angles that are crucial for filling the information gaps. For example, the system may prompt the user to provide a side-view image if the existing images are predominantly frontal. These additional photographs, once uploaded, provide the necessary data to refine the avatar model's parameters more accurately.

In another embodiment, the handler addresses specific body characteristics that are not typical or not well-represented in the base avatar models. In situations like pregnancy or the absence of a limb, the handler can guide the user through a manual customization process. This process involves adjusting particular avatar parameters under consideration to better reflect the user's unique physical features. For example, the handler might prompt the user to manually adjust the avatar's abdominal area to represent pregnancy or modify the limb structure to account for limb absence.

These interactive handlers ensure that the avatar generation system remains adaptable and responsive to diverse user needs. By incorporating user feedback and additional information, the system enhances its capability to generate avatars that accurately represent each user's unique physical attributes and characteristics.

In an embodiment, the resulting avatar model, after undergoing the optimization process, is subject to further customization. Users can modify various aspects of the avatar's appearance, such as hair, clothing, and accessories, to more closely align the avatar with their personal style. These customizations enhance the individuality and uniqueness of the avatar. The customized avatar model is then saved in the 3D avatar models storage 170, where it is cataloged for easy access and use across different platforms.

In an embodiment, the rendering unit 280 performs the dynamic visualization of the avatar model. The rendering unit 280 renders the avatar for various applications, enabling real-time interaction and integration in diverse digital environments. The applications include, but are not limited to, video generation services, gaming platforms, and virtual reality experiences. The rendering process undertaken by the rendering unit 280 involves sophisticated techniques that ensure the avatar model is displayed with high visual fidelity, responding realistically to various scenarios within the digital applications.

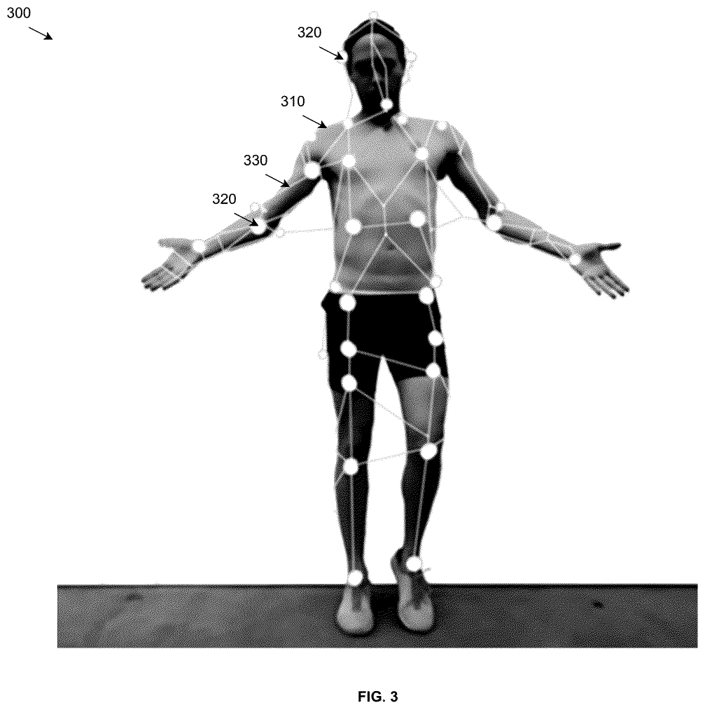

Referring to FIG. 3, a photographic image 300 of a person 310, captured in a specific standing pose is depicted, according to one embodiment. In this embodiment, the pose of person 310 is characterized by an upright stance, with arms resting naturally at the sides and feet positioned shoulder-width apart. Shown posture is typical for full-body imaging, providing a clear view of the body's proportions and contours.

The photographic image 300 of person 310 is overlaid with key points 320, represented as rounded dots, placed at significant anatomical landmarks. The key points 320 include, but are not limited to, the head, shoulders, elbows, wrists, hips, knees, and ankles. The arrangement of these points maps the body figure proportion and posture, forming a framework that captures the physical characteristics of the person.

Connecting these key points 320 are lines 330. The lines 330 illustrate the skeletal structure and the spatial relationships between different body parts. The lengths and angles of lines 330 provide essential data on the body figure dimensions and the pose dynamics. For example, lines connecting the shoulder to the elbow and the elbow to the wrist denote the arm's length and its position relative to the body.

In the context of the embodiments, the dots 320 and lines 330, with their respective coordinates or vectors mapped in either 2D or 3D space across different embodiments, represent the pose data for defining and replicating a user posture in the avatar generation service 110.

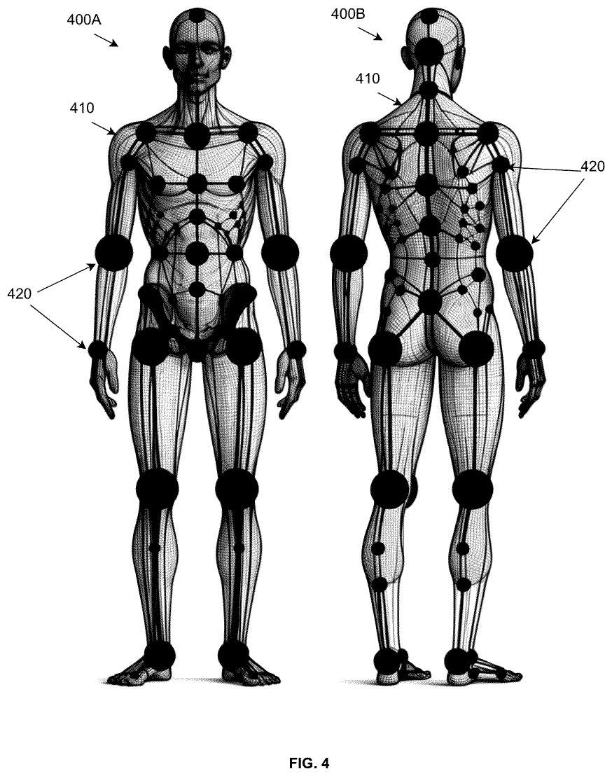

Referring to FIG. 4, a base 3D avatar model 410 is shown in two distinct projections, 400A and 400B, corresponding to user photographs and mirroring the user body pose, in accordance with one embodiment. The avatar model template portrayed demonstrates a network of key model points 420, which visually represent the parameters of the avatar model. These interconnected points 420 delineate the body figure proportions and posture by defining lengths and angles between key points 420, thereby identifying the avatar's pose and figure features.

In the embodiment, altering the parameters of the avatar model results in the corresponding movement of the graphical representation of dots 420, which are analogous to the key points 320 detected at pose detection unit 140. The adjustment of avatar model parameters and pose data structure causes the avatar model to transition between various postures and physical configurations, directly influencing the dots 420 in terms of dots 420 spatial positioning.

In an embodiment, the pose-template composing unit 250 utilizes a logical mapping between points 420 of the avatar model, representing avatar model parameters, and key points 320 of the pose data. While the pose data may contain fewer key points than those required for defining the 3D body figure parameters, due to the lesser measures needed for accurate pose representation, there exists a logical correlation for aligning the avatar model with the detected pose. For example, a key point 320 identifying the user's elbow in the pose data corresponds to a point 420 on the avatar model's elbow, ensuring that the avatar's arm bends accurately to mirror the user's posture.

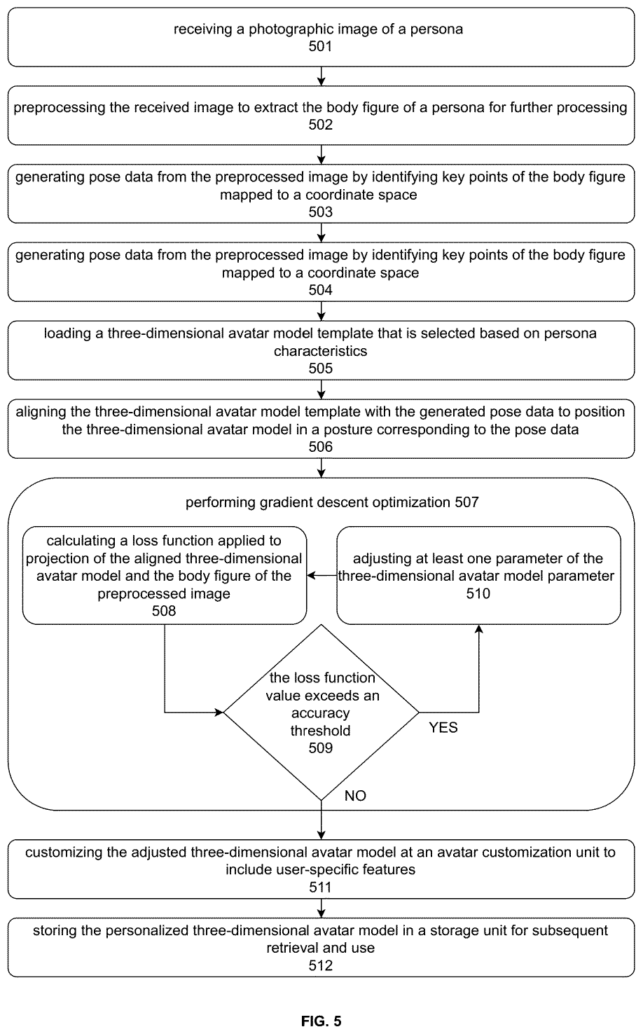

Referring to FIG. 5, a flowchart of a method for generating a personalized three-dimensional avatar model is shown, according to an embodiment. The method starts at 501 with the receiving of a photographic image of a persona, where the image includes a body figure of the persona. For example, an image can be received by avatar generation service 110 from device 120A. At 502, the image preprocessing unit 130 extracts the body figure from the received image for further processing, which includes refining the figure for accurate pose detection.

At 503, the pose detection unit 140 generates pose data from the preprocessed image by identifying key points of the body figure mapped to a coordinate space, thereby creating a detailed representation of the user's posture.

In an embodiment, the method includes loading a three-dimensional avatar model template at 504, which is selected based on persona characteristics and further refined by the pose data.

The alignment of the three-dimensional avatar model template with the generated pose data occurs at 506, positioning the avatar model in a posture corresponding to the pose data. For example, pose-template composing unit 250 aligns the base avatar model with the pose data. The method proceeds to 507, where the optimization unit 260 performs gradient descent optimization. This optimization includes calculating a loss function at 508, which is applied to the projection of the aligned avatar model and the body figure of the preprocessed image. If the loss function value exceeds an accuracy threshold, as evaluated at 509, at least one parameter of the avatar model is adjusted at 510. The accuracy threshold refers to a predefined limit or otherwise defined limit that determines the acceptability of the avatar's resemblance to the user images. An accuracy threshold represents the maximum allowable error between the avatar model and the photographic data used for its creation. When the value of the loss function, which measures discrepancies such as silhouette mismatch, feature misalignment, or color inaccuracies, exceeds this threshold, comparison against the accuracy threshold indicates that the avatar's current configuration does not sufficiently capture the user's physical and aesthetic characteristics.

At 511, the avatar customization unit 270 customizes the adjusted avatar model to include user-specific features, adding elements such as hairstyles, clothing, and skin color that reflect the persona's preferences. At 512, the personalized avatar model is stored in an avatar models storage 170 for subsequent retrieval and use in various applications.

In an embodiment, the method integrates additional steps to refine the avatar model further. For example, if the loss function indicates a disparity in areas covered by the body figure in the images, additional user guidance can be provided for manual customization or for the capture of supplemental images to achieve an accurate representation.

In the avatar generation process, certain scenarios arise where adjustments to the three-dimensional avatar model parameters using a descending loss function approach do not effectively reduce the loss function below the set accuracy threshold. This may occur when changes to one parameter within permissible limits fail to decrease the discrepancy without causing misalignments in other parameters, indicating a fundamental limitation in the model's parameter range or the initial data's sufficiency. When such limitations are identified, the three-dimensional avatar model that cannot be adjusted within predefined limits, the system triggers a protocol to involve user intervention. The user is then provided with options to manually adjust these problematic parameters directly, using a more refined control interface, or to upload additional images that offer clearer or alternate views of the challenging features.

1. A computer implemented method for generating a personalized three-dimensional avatar model, comprising:
receiving at least one photographic image of a persona;
preprocessing the received image to extract a body figure of a persona for further processing;
generating pose data from the preprocessed image by identifying key points of the body figure mapped to a coordinate space;
loading a three-dimensional avatar model template, wherein the three-dimensional avatar model template is selected based on persona characteristics;
aligning the three-dimensional avatar model template with the generated pose data to position the three-dimensional avatar model in a posture corresponding to the pose data;
performing gradient descent optimization, comprising:
calculating a loss function applied to projection of the aligned three-dimensional avatar model and the body figure of the preprocessed image, and
adjusting at least one parameter of the three-dimensional avatar model parameter if the loss function value exceeds an accuracy threshold;
customizing the adjusted three-dimensional avatar model at an avatar customization unit to include user-specific features; and
storing the personalized three-dimensional avatar model in a storage unit for subsequent retrieval and use.

2. The method of claim 1, wherein preprocessing the received image comprises a background removal operation to isolate the body figure of the persona.

3. The method of claim 1, wherein preprocessing the received image comprises defining the body figure contour of the persona.

4. The method of claim 1, wherein preprocessing the received image includes performing at least one image modification of resizing the image, cropping the image, and applying color filtering to the image.

5. The method of claim 1, wherein loading the three-dimensional avatar model template is based on the pose data.

6. The method of claim 1, wherein loading the three-dimensional avatar model template is based on at least one persona characteristic including gender, weight, height, or nationality.

7. The method of claim 1, wherein the loss function evaluates the disparity in areas covered by the body figure in the preprocessed image and areas covered by the projection of the three-dimensional avatar model.

8. The method of claim 3, wherein the loss function compares the contours of the body figure in the preprocessed images with contours of the projection of the three-dimensional avatar model.

9. The method of claim 1, wherein the gradient descent optimization is performed in a cycle until the loss function value falls below the accuracy threshold.

10. The method of claim 1, further comprising identifying parameters of the three-dimensional avatar model that cannot be adjusted within predefined limits to obtain an acceptable loss function value, and guiding the user to either customize the identified three-dimensional avatar model parameters or to upload an additional image to improve the avatar model.

11. A system for generating a personalized three-dimensional avatar model, the system comprising:
at least one processor and memory operably coupled to the at least one processor;
instructions that, when executed by the at least one processor, cause the at least one processor to execute:
an image preprocessing unit configured to receive and preprocess at least one photographic image of a persona to extract a body figure of the persona for further processing;
a pose detection unit configured to generate pose data from the preprocessed image by identifying key points of the body figure mapped to a coordinate space;
an avatar generation unit configured to load a three-dimensional avatar model template, wherein the template is selected based on persona characteristics, and align the template with the generated pose data to position the three-dimensional avatar model in a posture corresponding to the pose data;
an optimization unit within the avatar generation unit configured to perform gradient descent optimization by calculating a loss function applied to the projection of the aligned three-dimensional avatar model and the body figure of the preprocessed image, and adjusting at least one parameter of the three-dimensional avatar model if the loss function value exceeds an accuracy threshold;
an avatar customization unit within the avatar generation unit configured to customize the adjusted three-dimensional avatar model to include user-specific features; and
a database configured to store the personalized three-dimensional avatar model for subsequent retrieval and use.

12. The system of claim 11, wherein the image preprocessing unit is further configured to perform a background removal operation to isolate the body figure of the persona.

13. The system of claim 11, wherein the image preprocessing unit is further configured to define the body figure contour of the persona.

14. The system of claim 11, wherein the image preprocessing unit is further configured to perform at least one image modification including resizing the image, cropping the image, or applying color filtering to the image.

15. The system of claim 11, wherein the avatar generation unit is further configured to select the three-dimensional avatar model template based on the pose data.

16. The system of claim 11, wherein the avatar generation unit is further configured to select the three-dimensional avatar model template based on at least one persona characteristic including gender, weight, height, or nationality.

17. The system of claim 11, wherein the optimization unit is further configured to evaluate the disparity in the areas covered by the body figure in the preprocessed images and the area covered by the projection of the three-dimensional avatar model as part of the loss function.

18. The system of claim 13, wherein the optimization unit is further configured to compare the contours of the body figure in the preprocessed images with contours of the projection of the three-dimensional avatar model as part of the loss function.

19. The system of claim 11, wherein the optimization unit is further configured to perform the gradient descent optimization in a cycle until the loss function value falls below the accuracy threshold.

20. The system of claim 11, wherein the instructions that, when executed by the at least one processor, cause the at least one processor to further execute a user interface unit configured to identify parameters of the three-dimensional avatar model that cannot be adjusted within predefined limits to obtain an acceptable loss function value, and to guide the user to either customize the identified three-dimensional avatar model parameters or to upload an additional image to improve the avatar model.
